(19) United States
(12) Patent Application Publication
(10) Pub. No.: US 2011/0071896 A1
(43) Pub. Date: Mar. 24, 2011

(54) VIDEO OFFER BROKERAGE SYSTEM

(75) Inventors: Charles Dasher, Lawrenceville, GA (US); Alan Rouse, Lawrenceville, GA (US)

(73) Assignee: Tandberg Television Inc.

(21) Appl. No.: 12/563,401

(22) Filed: Sep. 21, 2009

(51) Int. Cl. G06Q 30/00

(52) U.S. Cl. 705/14.35; 705/14.1

(57) ABSTRACT

A video brokerage system provides a subscriber of a cable system access to a program in response to the subscriber entering a coupon code, where the program would otherwise not be viewable, or a discount is provided for viewing the program. In one embodiment, a coupon system interacts with a computer system operated by a merchant, which distributes the coupon code to the subscriber when acting as a customer of the merchant. The subscriber then provides the coupon code to the cable service provider when selecting a video-on demand program, allowing the subscriber to either receive a discount on a pay-per-view movie, or accessing a program that otherwise would not be accessible. Various validations tests are defined in conjunction with the cable service provider processing the coupon code, including checking: an expiration date of the coupon code, rating qualifiers, content provider qualifiers, etc.

### FIELD OF INVENTION

The disclosed invention generally related to systems and methods for generating, distributing, and redeeming electronic coupons allowing a viewer of a cable service provider to view a video program, or receive a discount to a video program selected by the viewer.

### BACKGROUND OF THE INVENTION

The use of coupons, in general, is well known as a mechanism for promoting certain products. Coupons have been traditionally printed in a paper medium, such as in a newspaper, physically obtained by the consumer and provided to the merchant at the time of sale for a product or service, where a discount is provided to the consumer. Other prior art systems, such as disclosed in U.S. Pat. No. 5,285,278, discloses an electronic method of transmission, where coupons can be locally printed or stored in a recording medium, such as an magnetically striped card. These types of coupons are used for redeeming discounts for products, and not for services offered by a service provider.

Another prior art system, such as disclosed in U.S. Pat. No. 6,057,872, does provide a couponing system for pay television services, but is based on a loyalty program which rewards viewers of the service provider. In one embodiment, coupons or credits are transmitted to the viewer's set top box and the set top box may analyze the viewer's usage pattern and accrue coupons for that user based on the usage pattern. These coupons can be redeemed by the viewer for viewing a pay-per-view (“PPV”) program. However, such a system does not provide flexibility in distributing coupons to users, as the coupons are determined by the set top box based on user's viewing habits.

Consequently, what is needed is a flexible system for generating and distributing electronic discounts for video services offered by one or more video service providers to its subscribers.

### BRIEF SUMMARY OF THE INVENTION

In one embodiment of the invention, a coupon system receives data used in generating a coupon. The coupon code is provide to a user by a merchant, when the user is acting as a customer for the merchant. The user can then enter the coupon code when acting as a viewer of a video service provider in order to receive a discount or receive viewing privileges that would otherwise not be obtained. In another embodiment, a method is defined for receiving the coupon code from a viewer in a cable system, wherein a coupon system validates the coupon code and determines the user is authorized to receive a discount or otherwise receive viewing privileges that would otherwise not be provided to the user.

Various other embodiments of the invention are possible, and the above embodiments are not intended to limit the scope of the invention beyond what is claimed herein.

### BRIEF DESCRIPTION OF THE SEVERAL VIEWS OF THE DRAWING(S)

Having thus described the invention in general terms, reference will now be made to the accompanying drawings, which are not necessarily drawn to scale.

FIG. 1 illustrates one embodiment of entities involved with generating a coupon.

FIG. 2 illustrates one embodiment of coupon distribution.

FIG. 3 illustrates one embodiment of coupon redemption.

FIG. 4 illustrates one embodiment of screen images associated with coupon redemption.

FIG. 5 illustrates one embodiment of a coupon system architecture.

FIG. 6 illustrates one embodiment of a process flow for coupon generation.

FIGS. 7a and 7b illustrate one embodiment of a process flow for coupon redemption and validation.

FIG. 8 illustrates one application of the coupon system.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, this patent at least covers various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods performed using computer hardware, apparatus, systems, and computer-readable program products. It should be understood that each block of the block diagrams and flowchart illustrations, respectively, may be implemented in part by computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Aspects

Providing discounts to viewers in a video service provider can also be referred to as providing electronic coupons to viewers. As used herein, an electronic coupon is information which can be used to provide a discount or privilege that otherwise would not be provided. It is “electronic” in that information is provided at one or more stages electronically and transmitted using electronic communication techniques, rather than solely using printed material, as is traditional with paper-based coupons and which require a physical coupon to be presented at time of purchase. However, this does not preclude certain information from being conveyed during part of the process via printed media. In one embodiment, the coupon indicates information that is provided for receiving the discount or privilege in conjunction with a service, not with purchasing a physical product.

The person using the coupon is variously referred to as a “user”, a “viewer”, or a “subscriber.” This is because in one embodiment used herein to illustrate the principles of the invention, the user is a subscriber of a cable service provider and is desirous of viewing a program at a reduced rate, or receiving authorization to view a program that otherwise would not be provided. Other embodiments are possible, and the use of such terms does not limit application of the invention to only video application, cable service providers, or to users having pre-existing billing arrangements with service providers.

The “program” viewed is illustrated herein as a video based movie, but the content of the program may be of other types, such as a sports program, documentary, etc. Further, although the principles of the present invention are disclosed in terms of viewing a program, the principles can apply to listening to an audio program, playing a video game, etc. Further, although the principles of the present invention is disclosed in terms of a cable service provider, the principles can apply to various other types of video service providers, using other technologies, such as satellite distribution of video signals, fixed wireless transmission, mobile wireless transmission, and Internet based technologies. The program is a video program which is available to subscribers of the cable service provider on a pay-per-view (“PPV”) basis, or is otherwise provided to subscribers (but not to the present viewer) on a subscription fee basis. Thus, the program is available for viewing without redeeming the coupon, but may require a usage-specific fee (e.g., as in PPV) or subscription fee (e.g., subscribing to a particular service level). It is presumed that the viewer is electing to redeem the coupon so as to avoid paying the full usage specific fee (e.g., receiving a discount or no charge), or to avoid paying the required service level (otherwise, they would be entitled to view the program without a coupon). Typically, the coupon is limited in redemption, as it can be typically (but not necessarily) used once by a cable subscriber to view a program, or receive a discount when viewing a program. In other embodiments, the coupon can be a “pass” for a limited number of movies, a limited number of time, or based on some other criteria.

The service related aspects can be divided into three distinct phases. These are the coupon generation phase, the coupon distribution phase, and the coupon redemption phase. Within each phase, there are various embodiments, so that one of the embodiments in the coupon generation phase can be combined with one of the embodiments associated with the coupon distribution phase, and further combined with one of the embodiments of the coupon redemption phase. Thus, it is apparent that there are various combinations that are possible, and one skilled in the art will be able to appreciate that there are many combinations and embodiments possible.

### Service Aspect: Coupon Generation Phase

The coupon generation phase refers to aspects associated with gathering and synthesizing various data inputs for formulating a coupon. The coupon itself comprises information which can be used by a viewer to receive a discount to a pay-per-view program, or otherwise gain access to viewing a program. Thus, a viewer may be subscriber of a video service provider, typically, a cable service provider, with access to various PPV programs. The coupon may entitle the viewer to a discount based on a percentage or a flat fee (e.g., 50% off or $5 off) of the regular charge incurred when requesting a PPV. Or, the coupon may entitle the viewer to access a program associated with a service that normally is not accessible by the user. For example, the user may not be a subscriber to a premium programming channel (e.g., HBO®), but the coupon provides limited access to the subscriber in order to access the programming channel. Such marketing mechanisms allow the viewer to sample the premium programming channel as an enticement for subscribing to the service on a regular basis.

The coupon can be generated so as to be targeted to a particular subscriber, to a particular class of subscribers, or not targeted at all. For purposes of reference herein, the former two categories are subscriber “targeted” coupon and the last category is referred to as a “generic” coupon. Further, the coupon can be redeemed for a specific content or type of movie (which is referred to as a coupon targeted to particular content) or any type of program (which is referred to as a coupon for generic content). Thus, a coupon can be targeted for a particular individual and redeemable for a particular movie, or the coupon could be targeted for any subscriber and redeemable for any PPV movie.

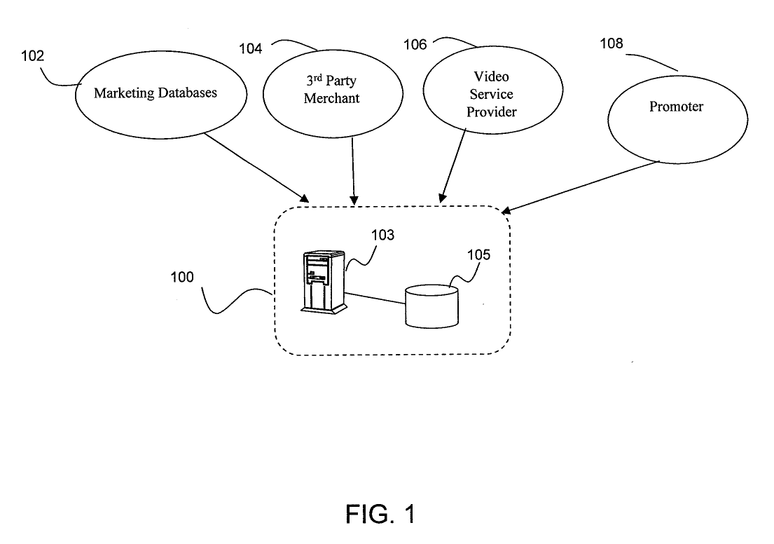

Based on the type of coupon, the Coupon System (which processes the data associated with the various phases) receives and analyzes various types of inputs to create or generate a coupon. This is illustrated in FIG. 1 which discloses the Coupon System 100 (more of the particular architecture of the Coupon System will be discussed later). One potential input to the Coupon System includes data obtained from a third-party marketing database 102. These third party databases provide various information regarding particular individuals or demographics of individuals living in particular areas (such as postal zip codes) and are well known and available from various sources. These can be used to identify particular types of viewers in a given area or identify characteristics of particular viewers in a given area. For example, lists of individuals who are cable subscribers with a certain income level, interest, religious affiliation, family status, etc., can be obtained for a viewing area. Thus, if the coupon is intended to target provision of programs for pre-school children, these third party marketing databases can provide lists of families with pre-school children. These “lists” may comprise names, addresses, email addresses, etc of specific individuals. This information may be used in the subsequent phase, coupon distribution.

Another input to the Coupon System 100 is information from specific third party merchants (“Merchant”) 104 selling a service or product. The Merchant typically retains information regarding its customers, which may include the customer's buying habits, which potentially allows the Merchant to derive information about its customers. For example, many grocery store chains offer discounts to purchasers using a “shopper's discount card” which allows the grocery store to track the purchase habits of its customers. Thus, a grocery store chain can observe when an individual begins to regularly purchase a certain type of product (e.g., baby diapers), and thus is able to ascertain that the individual's family status. Further, it is well known that airlines also track the trips made by their customers, and it is possible to derive potential interests of their customers based on the locations that they fly to. Such information from a Merchant could be useful in targeting a coupon to a particular viewer. For example, viewers that travel frequently may be offered a coupon for viewing a travel channel program (which the viewer normally does not view because they do not subscribe to that channel). As evident, the coupon system uses the inputs in one embodiment to ascertain individuals with have certain criteria, including that the individual is a common customer of the Merchant and Video (e.g., Cable) Service Provider, or has a known interest which can be aligned with viewing opportunities with the Cable Service Provider.

Another source of data to the Coupon System 100 is information from the video service provider 106. Typically, the video service provider is a cable service provider (“CSP”), but this should not be construed as limiting the video service provider to a certain type of technology. The CSP can be aware via various mechanisms of the viewing habits of the viewer, and is aware of the viewer's subscription status. For example, a CSP typically offers various levels of service at differing subscription levels (and different prices) to its viewers. Consequently, the CSP knows whether the viewer is subscribing to a basic level of service or a premium level of service. A basic level of service may prohibit the user from viewing the content on certain channels, and hence it would be appropriate to offer such viewers a coupon for viewing these channels. Obviously, if a subscriber has access to a the full complement of programs offered by the CSP, then it would not make sense to offer a coupon for allowing access to an already available program to such a subscriber. However, even a premium level subscriber could be offered a coupon for a PPV program which provides a discount. This would allow the CSP to increase usage of PPV programs amount its premium level subscribers.

Another source of data to the Coupon System 100 is information from a promoter 108. The promoter typically is associated with a particular form or type of content. For example, the promoter may be promoting an upcoming movie, which is to be available for PPV by the CSP. Other examples include the promoter advertising a one time sporting event (international soccer championship). Other promoters may be distributing a series of programs (e.g., cooking or travel related content) and is attempting to increase viewership in general. One such example of a promoter could be a content distributor or content provider, such as HBO®. Thus, targeting a coupon for particular content or video program may be compatible with the goals of the promoter.

As evident, each of the input sources provides information that can be used to target a coupon to a particular subscriber or class, or target the content of the coupon. Thus, these types of information may be used when providing a subscriber targeted or program targeted coupon. Other forms of input are possible that can be used to identify a subscriber or class of subscribers, or used to identify particular content that a coupon can target. It evident that not all information sources are required to generate a coupon. If a coupon is directed to generic subscribers in a viewing area, then there is no need to ascertain particular subscriber aspects. Alternatively, if a coupon is generic with respect to content, it is not necessary to have input from a promoter targeting a particular program. However, if coupons are targeted to particular types of subscriber's (e.g., families with pre-teenage children) and the coupons are targeted for a particular type of program (an upcoming movie where the plot involves pre-teenage children), then the Coupon System may use such inputs in generating such coupons.

In one embodiment, the Coupon System 100 receives data from the various sources 102, 104, 106, and 108. Marketing databases typically offer their information at a price, so that it is possible for the Coupon System to access such data (although payment for receiving such data may be required). Further, a promoter 108 typically pays to make promote a particular movie, so again, that information may be available as an input. However, Merchants 104 and video service providers 106 may guard their customer information and may not readily disclose it to the Coupon System. In such cases, the Coupon System may controlled and/or operated by the Merchant or the Video Service Provider. Thus, if a CSP operates or controls the Coupon System, the CSP may be willing to provide subscriber viewing habits to the Coupon System.

In other embodiments, the coupon generation process may be distributed, with certain aspects occurring in the coupon system, and other aspects occurring in a Merchant's system. Thus, in other embodiments, a hybrid arrangement may occur where a portion of the coupon generating is done in a distributed basis. For example, the Coupon System may be operated by a CSP, and the Coupon System generates a coupon for a particular program (based on input from a promoter) for certain subscribers of a certain income level (using input from a marketing database) and for subscribers which do not regularly elect to view a PPV program (using input from the CSP). The Coupon System may generate a fixed number of coupons, and electronically provide them to the Merchant along with information indicating how the coupons were determined. The Merchant may then elect to provide these coupons to certain frequent customers. For example, the Merchant could be a pizza chain and is advertising a promotion that provides a coupon for a free movie when a pizza is purchases and delivered. Alternatively, the Merchant could be a grocery store that provide a coupon to certain shoppers spending over $100 on groceries. Further variations are possible.

The coupons generated by the Coupon System comprises typically a computer file comprising coupon codes. The codes are redeemed and typically entered by a viewer to receive access or a discount. Thus, generating the coupons involves generating a computer file comprising coupon codes. The coupons codes are typically unique, and typically have a limited time of use (“lifetime”) before they expire, and typically can be used once (“limited use”). However, in other embodiments, they can be used more than once by a viewer, or only once by multiple viewers. Consequently, providing coupons to the Merchant in the above example comprises transferring a file with the various coupon codes. These codes can be indexed and numbered, and can further be associated in bulk or individually with data that was used to generate the coupon. Thus, coupon codes can be associated for a particular program or subscriber type either by information contained in the coupon file (for each record) or in a separate file. It is also possible to even associate a coupon code for a particular subscriber (which is the case when certain forms of distribution are being used).

It is necessary for the CSP involved in redemption to plan for redemption of a coupon, and this is typically done at the same time that the coupons are generated, and usually prior to distribution of the coupons. Thus, the CSP may also be provided with the coupon code file, or a subset thereof, so that redeemed codes can be compared as valid. Typically, at least the Coupon System retains a copy of the coupon file after transmitting it.

### Service Aspect: Coupon Distribution Phase

The coupon distribution phase refers to the transfer of the coupon to the subscriber. (This can also include distribution of the coupon code file to the appropriate CSPs, and the distinction will generally be clear from the context.)

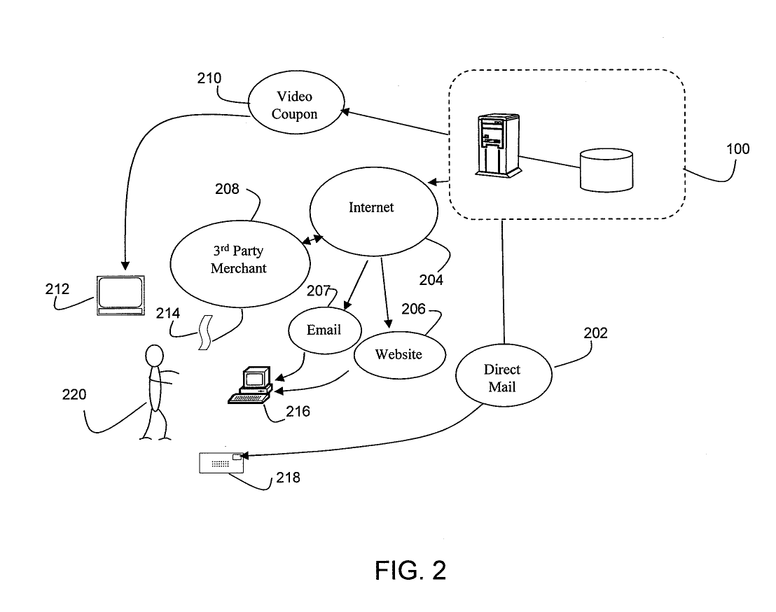

The coupons are often distributed in electronic form, but can be transmitted in a physical manner. Some of the various methods of distributing coupons are illustrated in FIG. 2. The coupons originate from the Coupon System 100 of FIG. 2 as a result of the previously discussed coupon generation phase. The Coupon System 100 can provide the data to a direct mail marketing entity (not shown) that prints out the coupon codes on paper, along with any other desired promotional material, and mails the coupon as a direct mailing 202 resulting in an envelope 218 being delivered to the viewer 220 via postal mail or other suitable delivery service. The Coupon System may provide the associated viewer's name and address, or may provide the coupon code in a file with the names and addresses separately determined (either by the Coupon System or the direct mail marketer). Other forms of direct mail are possible, including providing an insert in a newspaper, magazine, or other tangible item delivered to the viewer 220. Typically, the coupon bears the coupon code, and instructions for redeeming the coupon. If the coupon is for specific content, then additional information is typically provided indicating the particular content that can be redeemed using the coupon.

Various electronic forms are depicted in FIG. 2. In one embodiment, the coupon is electronically transferred via email to an email address 207 associated with the user 220. Thus, a user can access the coupon using a computer 216, or other suitable device, including a cell phone with a mobile browser, netbook, etc. The coupon is typically sent as an attachment that can be printed out, or the coupon code can otherwise be noted by the user (e.g., the user could copy the coupon code onto a separate piece of paper. An alternative is loading the coupon codes in a website 206, where the user 220 can use a computer 216 to access, and be allocated a coupon as appropriate. Well known computer systems comprising processors, memory, and disk storage can be used to construct the email servers 207 or web servers 206. In either embodiment, the coupon code is typically associated with a particular user, since the user individually receives the coupon code.

Other forms of coupon distribution are possible, and one such distribution method is illustrated as a “video coupon” 210, which provides the coupon to the user's television set 212. This form of distribution can provide a visual indication of the coupon code to the user in various circumstances. For example, in one embodiment, the cable headend sends the coupon code to the set top box (not shown) which is programmed to provide a “banner” at the bottom of the television screen which scrolls a message to the user (e.g., “your coupon code for viewing a free premium channel is 12345”). Alternatively, when the user selects a function key on their remote, the user can invoke the PPV function and be informed of the code at that time. Typically, these codes have a limited duration, so that they must be used within a time period. Other forms of electronic distribution are possible, including instant messaging, short messaging service (SMS) used for wireless service, etc.

Another form of distribution involves a third party merchant (“Merchant”) 208. In this form, coupon file is distributed to the computer system operated by the Merchant. The Merchant may provide the coupon code on a printed receipt 214 at the time of purchase by the viewer 220 when making a purchase from the Merchant. Thus, a user purchasing groceries at a store may have a coupon code printed on the bottom of the receipt informing them they can redeem the coupon code at a CSP. It is well known that Merchants have “loyalty” reward systems in place for identifying a purchaser (such as using a frequent shopping discount card) at checkout. Thus, the Merchant's systems can allocate a coupon code from a set previously provided to the Merchant, or query in real time the Coupon System for a coupon code. Other variations are possible. Typically, these Merchant loyal rewards systems comprise a processor and database for storing shopper's purchasing history, related marketing data, and other shopper profile data. For example, the Merchant may have separate pre-printed coupons which are physically handed to the purchaser at the time of purchase. Regardless of how the coupon is provided to the purchaser, the purchaser is informed of the coupon code by the Merchant. The purchaser is typically the viewer that is redeeming the coupon.

Other forms of distribution are possible. For example, the coupon code can be integrated into a product, such as pre-printed on the inside label, lid, or wrapping of a product.

Upon distribution of the coupon code, the Coupon System may correlate the coupon code with the user. For example, when distributing the coupon code via email, direct mail, or in conjunction with a Merchant's buyer loyalty program, the coupon code is associated with the user in some manner. In other embodiments, such as when the coupon code is obtained from the website, pre-printed on a product label, or on a card that is handed to a purchaser, the Coupon System may not be able to track which individual receives the coupon code. Thus, it is possible for the redemption of the coupon to be limited to certain subscribers (e.g., the coupon cannot be redeemed by another household).

In other embodiments, other information can be combined with the coupon code so that the coupon generation and coupon distribution is intermixed. For example, a Merchant may receive a list of coupon codes applicable for redemption for a particular movie, or a movie from a particular content provider (e.g., HBO®). (This is part of the distribution phase.) The Merchant can then combine information about particular shoppers when selecting the coupon, so that coupons are determined to be allocated for certain groups of shoppers. (This could be considered part of the generation phase). The Merchant could accomplish this in conjunction with obtaining information from another party. For example, the Merchant could receive a list of desired programs or past programs viewed by the subscriber from a cable service provider. Finally, once the Merchant has completed the processing of determining which coupons should be allocated to which shoppers, the Merchant can provide the coupon code to the shopper upon checkout. (This could be considered as part of the distribution phase again.) Thus, the phases are not required to occur as wholly distinct and complete processing steps.

### Service Aspect: Coupon Redemption Phase

The coupon redemption phase refers to the procedures and systems used in redeeming the coupon by the viewer, in order to receive a discount or to otherwise access a program that the subscriber would not be able to normally view. The viewer may be made aware of the program to be redeemed by consulting a program guide (on-line or otherwise) informing the viewer of the various programs available for viewing. In other embodiments, the user may be informed via a VOD service, presenting the user with a list of movies or programs that can be requested. As noted, if the program is already available to subscribers of a certain subscriber service level, then the viewer is already authorized to view the program, and the coupon would not be of little value to the subscriber. However, such a subscriber could benefit from receiving discounts to PPV events. As used herein “discount” means a reduction in price charged which includes no price charged.

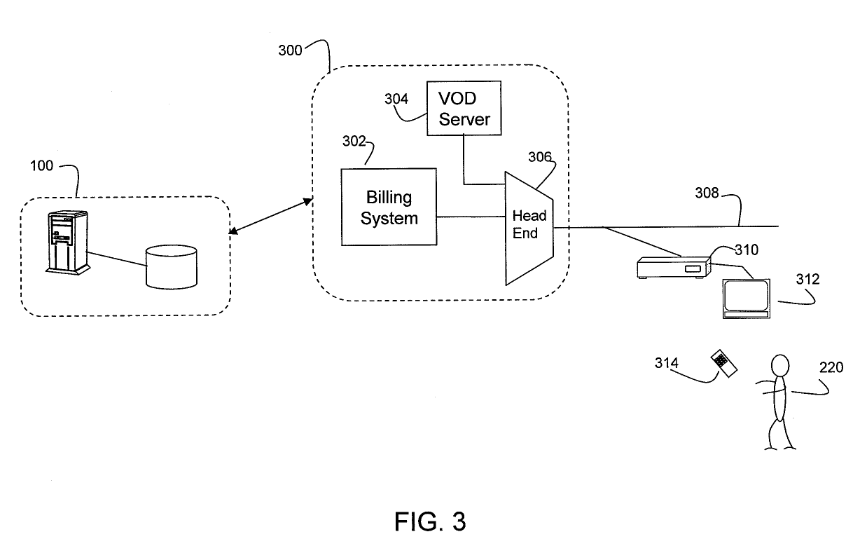

FIG. 3 illustrates one embodiment associated with redeeming the coupon. FIG. 3 illustrates the Coupon System 100 that communicates with the cable service provider 300, which comprising a billing system 302, a video-on-demand (VOD) server 304, a headend 306. Further, the CSP typically has a hybrid fiber coax (HFC) distribution network 308 to which a set top box (STB) 310 is connected to receive signals. The STB in turn is connected to the viewer's television set 312. The user typically uses a remote controller 314 as an input device. The cable distribution network 308 is presumed in this embodiment to have a two-way capability.

The user 220 typically elects the desired program, and typically one of two possible circumstances exist: 1) the program is a PPV, and the coupon code is used to provide a discount or avoid the charge, or 2) the program is not a PPV program, but a program otherwise available via subscription to a service level which the user is not authorized for.

In the first case, the existing PPV procedures can be invoked, which are then modified to allow the user to enter the coupon code, and the discount is then indicated. In the second case, the user elects the program, and instead of receiving a denial of service, the user is prompted to enter the coupon code. Upon successful validation of the code, the user may view the program. Validation as used herein refers to the various tests that may occur to ensure the coupon code allows the subscriber to redeem the coupon code.

The user typically enters the coupon code using the remote controller 314 in response to visual instructions provided on the television 312. These visual instructions can be generated by the STB 30, or by other devices in the CSP 300 as is well known in the arts. In one embodiment, the coupon code is passed to the Coupon System 100, which may query a billing system 302 for further information. In other embodiments, the Coupon System can query other systems, such as a promoter to ensure the coupon code is valid. Upon validation, the Coupon System 100 instructs the VOD server (or other component) to provide the program to the viewer. In some cases, these may require also sending appropriate decryption information to the STB to allow viewing of the program.

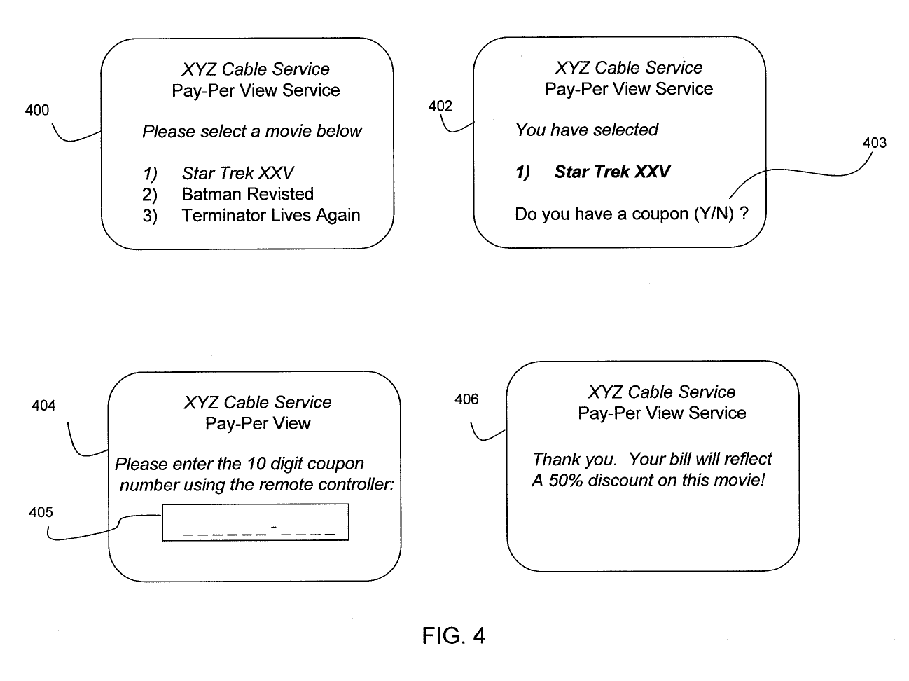

One embodiment of the graphical user interface (GUI) for a user interacting with the service is shown in FIG. 4. This can be accomplished by the CSP downloading an application to the STB modifying the menu processing for VOD programs. In this figure, screen 400 is an image which a user may be presented in selecting from a list of recently released movies. A typical menu structure is shown where the user selects a movie using a number, which is entered using a remote controller. After selecting a movie, the next screen image 402 is presented confirming the selection and prompting 403 the user as to whether a coupon is being used. Assuming the user responded “yes,” then screen image 404 is presented. There, the user is prompted to enter the coupon code, which in this embodiment is a 10 digit number separated by a dash. The user enters this value in the text box 405 using the numerical keys of the remote controller. Upon completing the coupon code entry, the next screen presented is screen 406, which confirms a discount provided to the viewer. In other embodiments, the user may receive the program at no charge, which would result in the user being informed that there would be not charge.

### Coupon System Architecture

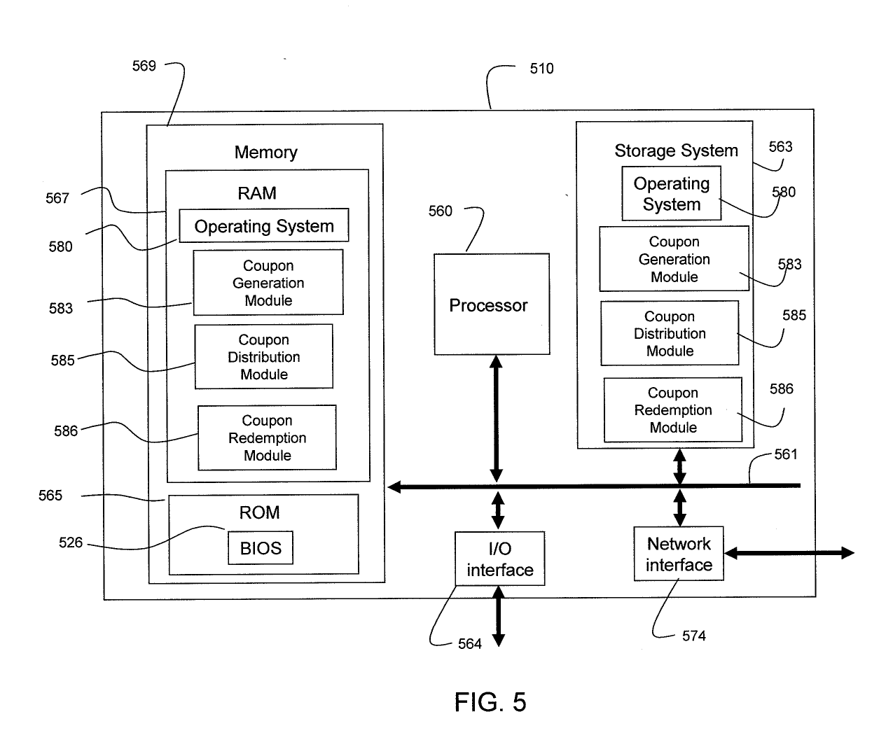

The Coupon System 100 of FIG. 1 comprises a processor 103 and a data store 105. In various embodiments, the datastore can be a disk-storage system or a database. The system architecture is shown in FIG. 5 in further detail. In one embodiment, the Coupon System 510 is shown as comprising a processor 560, which can be a single microprocessor as shown, or in other embodiments, multiple processors functioning as a logical entity. The processor 560 typically communicates to primary memory 569 that comprises RAM type memory 567 and ROM type memory 565. The RAM memory stores a copy of the operating system 580 to control the overall system, and the RAM further stores three program modules. The coupon generation module 583 is the module that receives various inputs and generates the coupons, which can be subscriber targeted or generic, and/or content targeted/generic. The coupon distribution module 585 then distributes the coupons previously generated using any of the aforementioned mechanisms. Finally, the coupon redemption module 586 may validate the coupon code as requested by a cable service provider communicating with the Coupon System 510. The basic input-output system (BIOS) module 526 is programming code that initially controls the system upon power up.

The storage system 563 may be a separate disk storage system, or may be integrated, and also stores a copy of the operating system 580, the coupon generation module 583, the coupon distribution module 585, and the coupon redemption module 586. These are stored so that they can be loaded into main memory 576 upon power up.

The memory and processor communication over a bus 561, and can also send and receive data from an input/output interface 564 or a network interface 574, the latter which is often connected to the Internet (not shown).

A variety of computer systems architectures can be used for the Coupon System, including distributed processors, servers, various types of operating systems, programming languages, etc, that are well known in the art.

### Coupon Generation Processing

The coupon generation module is the program that generates the coupon file. The coupon file is a series of records, each which may be called a coupon record, and where each coupon record has one coupon code. Typically, the coupon records are indexed by their respective coupon code values, but not necessarily. The process of generating the coupon file (and the content and structure of the coupon file and coupon records) is dependent on the type of coupons generated.

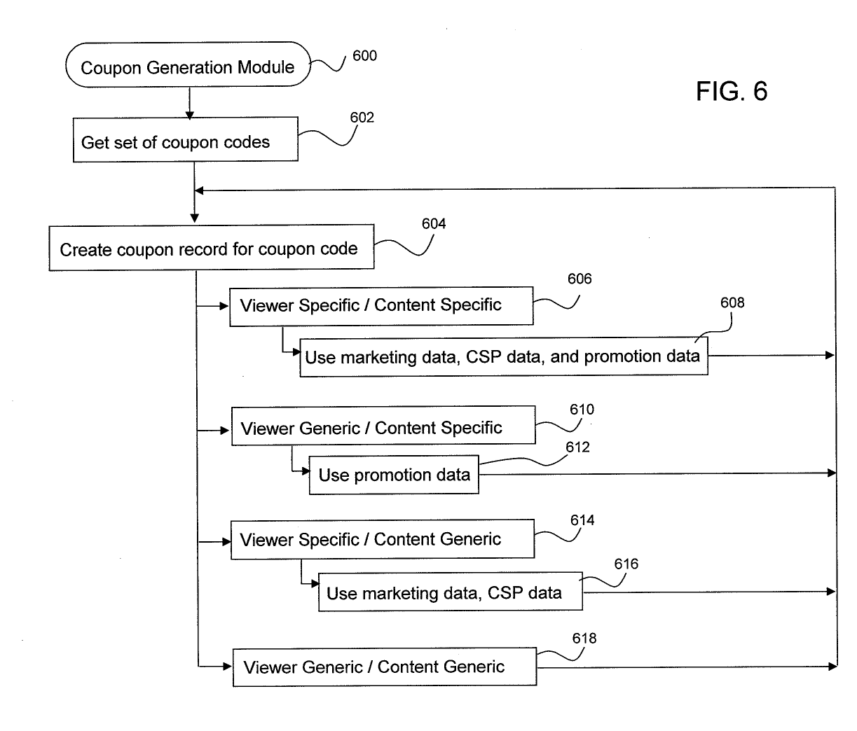

At a high level, generating the coupon file involves associating or allocating a set of coupon codes to the records, along with other information as appropriate. One embodiment of this process is shown in FIG. 6, which illustrates the type of coupon records which can be created, which influences the analysis of the inputs available to the Coupon System for generating the coupon file.

The process 600 begins with obtaining a set of coupon codes 602 which are to be used in creating the records. Typically, this is a sequential range of unique values. Typically, each distinct coupon code corresponds to one record and the process loops to create the coupon record in step 604. There are four types of records shown in FIG. 6 that can be created, and the records in a coupon file can be homogenous, or the records can differ.

The first type is viewer specific/content specific 606. This type of coupon record is created for a specific viewer (subscriber), or type of viewer. Essentially, the viewer has been targeted based on some criteria. The viewer can be targeted individually or as having a specific attribute. Further, the coupon is applicable for specific content. Thus, there is some association of the content for which the coupon can be used. For example, coupon records can be created for viewers of a particular CSP that have an income greater than a defined threshold and the coupon can be for redeeming a particular PPV sporting event program. Thus, to create this type of record, the Coupon System requires some sort of input data, which can be marketing data and/or data from a CSP that is used to identify a subscriber or type of subscriber 608. In addition, because particular content is targeted, promotion data is also required. Typically this originates from a promoter or the CSP, which can be of various types. Thus, a program producer may provide incentives for viewers to see programs the producer distributes, or the CSP may provide incentives for its viewers to “upgrade” their service level. The exact process of forming the coupons and the structure of the coupon file can vary, and those skilled in the art can readily define different embodiments of viewer targeted/content targeted coupons.

Another type of coupon record that can be created is shown in step 610 which is viewer generic/content specific. Because this is viewer generic, it is not targeted to a specific viewer or type of viewer. Thus, the Coupon System only needs to use promotion data 612 in forming the record, and there is no need for analyzing data pertaining to individual subscribers or attributes of types of subscribers. In this case, the coupon is directed to any viewer but its purpose is to promote viewing of a particular program. In generating a coupon that is generic to viewers, it is often the case that the coupon is used to provide a discount to a PPV event. Because the coupon is generic to all viewers, some of those viewers are likely subscribers at a premium level—that is, they can readily access all programs that can be accessed via subscription. It would provide little benefit to provide these viewers a coupon authorizing access to channels they can already access (because they can access all channels). On the other hand, even premium level viewers would benefit from a discount from a PPV event. Nevertheless, there can be benefits to distributing such coupons allowing access to premium channels, as it would benefit those subscribers which do not already have access to such premium channels.

The third type of coupon record that can be created in viewer specific/content generic in step 614. This type of coupon is targeted to a specific viewer, or type of viewer, but is not specific to discounting or providing access to any particular program. For example, a CSP may intend to target those subscribers which do not presently subscribe to a premium level of service. The CSP may distribute a coupon to these select viewers allowing them to view programs they otherwise are not able to, and thereby incent the viewer to potentially upgrade their service. In order to accomplish this, the Coupon System must use the marketing or CSP data 616 to identify which viewers are targeted. Because the coupon is generic to the content, there is no need for any promotion data to identify any particular content the coupon can be redeemed towards.

The exact scope of a “generic” coupon with respect to content may have some limitations associated with this. For example, the generic program may provide a discount to any PPV program on a local CSP. (Although this is limited to PPV, it is generic in the sense that it is not limited to only one particular PPV program.) However, once the coupon is tied to a particular PPV program title, then it is typically referred to as a “targeted” coupon with respect to the content. Similarly, a coupon can be limited to viewing of a premium channel and still be considered as “generic.” Further, the CSP may further limit application of a coupon. For example, even though a coupon is generic in the sense that it provides a discount to a PPV movie, a CSP involved in redeeming the coupon may further limit redemption to a specific set of titles, or exclude certain titles. Thus, even though a coupon record includes information that suggests the coupon is generic with respect to content, a CSP can limit application of the coupon, and effectively make the coupon content limited or specific.

The last type of coupon record structure is shown in step 618. This is a viewer generic/content generic coupon. Because this does not target any particular viewer or content, no data is required to target a particular viewer nor is any promotional information required to identify any particular content. Typically, the CSP involved in redeeming such a coupon may chose to further limit application of the coupon to certain content.

The particular process used in steps 608, 612, 616, and 618 can vary, and those skilled in the art can readily define further algorithms for forming the records and the structure of the records. In the various combinations above, even if no viewer specific or content specific requirements for the coupon record are included in the record, that does not mean that further information is included in the coupon record. Various other information is typically provided with the coupon, and these fields are identified below.

### Coupon Record Structure

The coupon generation process typically results in creating a set of records in a database. The coupon records are typically indexed by coupon code, and each record comprises the following fields. In many embodiments, certain fields are optional, and their presence is dependent on whether the information is required based on the type of record being created. For example, if the coupons are generic to the subscriber, then it is not necessary to include viewer information. However, if the coupon is specific to a subscriber, then typically some viewer identification information is included. Other structures of the record can be used and the following represents one embodiment.

The following fields can also be used as qualifiers used in validating a request comprising a coupon code and a program identifier. Other information may be provided in conjunction with the query. The query is then compared to the various qualifiers indicated in the corresponding coupon record to ensure that the request of the movie is compatible with the coupon code data.

Coupon Code. The coupon code is the value entered by the user to redeem the coupon. The coupon code value and structure may vary, and in one embodiment this is a 10 digit number. Other embodiments may use few or more digits, and may use alphanumeric symbols as well. In some embodiments, the records are indexed by the coupon code, and the coupon code file comprises a series of records indexed on sequentially determined values.

Viewer Identifier. This is information identifies the viewer, and can comprise a variety of information. For example, the viewer's name and address may be included. In other embodiments, the CSP may provide an account number. In some embodiments the field is populated when the coupon file is generated, allowing the coupon to be targeted for distribution to that viewer. In other embodiments, this field is left blank when generating the coupon file and populated as the coupon is redeemed. This presupposes a mechanism for identifying the viewer redeeming the coupon. This could be a set top box identifier, or other viewer identification.

CSP Identifier. The coupons may be generated for a particular CSP. The CSP identifier indicates the CSP that is accepting the coupon codes. This information is also typically used when verify a coupon code redeemed by a subscriber. The CSP typically includes identifying information when verifying the coupon code, to ensure that the appropriate codes generated for the CSP are being used by the viewer. Typically, the Coupon System may house coupon codes that are allocated for different CSPs. Thus, it is not sufficient to merely check at the Coupon System when redeeming a code whether it was previously generated, but the Coupon System must also check that the coupon code is being redeemed for the CSP that the coupon code was created for. In some embodiments the field is populated when the coupon file is generated, allowing the coupon to be targeted for that CSP. In other embodiments, this field is left blank when generating the coupon file and populated as the coupon is redeemed, thereby indicating the CSP involved in redeeming the coupon code.

Expiration Date. The expiration date indicates the last day which the coupon code is valid. This ensures that the once generated, the code does not have an infinite lifetime.

Use Indicator. The coupon code typically has a limited use, which typically is a single use. In other embodiments, it may have a limited number of uses greater than one. For example, a single code can be published allowing the first 50 users to receive a free program. It is still possible to have multiple codes, so that multiple groups of the 50 first users can redeem the coupon codes. In other embodiments, the prior use is a flag that is set in each coupon record after the coupon code is first used.

Distribution Channel. The distribution channel indicates which distribution channel was used to place the coupon code with the viewer. This allows tracking the relative effectiveness of the distribution channel. Thus, a CSP may initiate coupons in various distribution channels and the relative effectiveness can be compared after redemption.

Discount Level. The discount level indicates how much of a discount is to be provided. This can be indicated as a percentage or a flat fee. A flag can be used to indicate “free” or alternatively, the discount can be indicated as 100%.

Access Limits. This field may comprise data used to limit access to the programs in various ways. The redemption of a coupon may be restricted to use for certain types of programs, times, or other limitations. For example, a generic coupon entitling the viewer to a free PPV movie may exclude its application to “adult” rated movies. Thus, a rating indicator may be used to qualify redemption of a coupon code for viewing a program. This access limits can be indicated by inclusion (e.g., this coupon code is only redeemable for G or PG rated movies) or by exclusion (e.g., this coupon code cannot redeem R or Adult rated content). Other restrictions may prohibit using the coupon for certain other types of movies, such as those from a certain originator or distributor. Other access limits may allow the coupon to be used for only certain types of programs (e.g., a free movie from a certain program distributor).

Targeted Content Identifier. This field may be used to identify a particular video program (e.g., a program identifier) which the coupon can redeem. This can be a numerical identifier, a program title, etc. This identifier may conform to a metadata asset identifier having a structure that is well known in the industry. The coupon system may use this field if the coupon is limited to being redeemed for a specific video program or content. In some embodiments the field is populated when the coupon file is generated. In other embodiments, this field is left blank when generating the coupon file and can be populated by a CSP before the coupons are redeemed, thereby allowing the CSP to define further limitations as to how the coupon can be redeemed on the CSP's system.

Promoter Identifier. If particular content is being promoted, the promoter identifier may identify the promoter of the content to facilitate reconciliation of payments. For example, if XYZ Promoters is promoting a given movie, XYZ Promoters may provide reimbursement for each coupon redeemed. In some embodiments, the promoter identifier may be a content provider, or distributor of programming (e.g., HBO®). This can be used by the Coupon System to facilitate settling of accounts on a periodic basis.

### Coupon Distribution Process

The coupon distribution module executes a coupon distribution process. This process can occur in various ways, and hence the processing is highly dependent on the method selected. Further, this can occur by a distinct system, so that this function can occur on another system, or by another entity. Some of the methods are described below:

Direct Distribution Via Email. The coupons can be electronically transmitted to viewers via email. In this case, the coupons can be viewer specific, in which case the viewer's email is correlated with the type of coupon. Alternatively, the coupons can be viewer generic. However, even if the coupon is viewer generic, the Coupon System can email the coupon to specific viewers, but the coupon file does not store any information about the specific viewers receiving the coupon. Typically, the coupons are mailed to subscriber's associated with particular CSPs or thought to be subscribers of a service provider, but this is not always required. Generally, coupons are not intentionally sent to viewers that known to be unable to redeem the coupons. In this case, the Coupon System or another email server system can originate the email.

Direct Distribution via Third Party Direct Mailers. The coupon data can be provided to a third party direct mailer, who can print coupons and insert them in various direct mail marketing pieces. Again, the coupons can be tailored to a viewer or type of viewers, or they can be generic to the viewer. In this instance, an electronic file is typically transferred to the direct mail marketer where they perform further distribution steps.

Indirect Distribution Via Web Site. The Coupon System may provide a third party web site with the coupon file. The web site then allocates a coupon to a viewer visiting the web site. The coupon records are typically generic to a subscriber, since the identity of the visitor to the web site is typically not known. However, the web site may verify that the visitor is a subscriber of particular CSP, or otherwise obtain the identify of the subscriber and then record that information in the coupon file. In some instances, the web site may prompt the visitor for information, such as their name or other information to ensure that the coupon is appropriate for the viewer (e.g., compatible with the visitor's CSP).

Indirect Distribution Via Third Party Merchant. The Coupon System may create a coupon file and transmit the file to a third party Merchant. The Merchant may then process the file in conjunction with their loyalty rewards system to then create the appropriate coupons.

For example, a CSP desires to enter into a cross promotional arrangement with a grocery store chain that is located in the CSP's serving area. The CSP arranges for 10,000 coupon codes to be generated and provided to the grocery store chain. The grocery store chains provides the coupon (printed on the grocer's receipt) at checkout for each shopper purchasing over $100 in groceries. Thus, the Merchant is provided with the coupon codes and the program content information, and determines which of its customers can receive the coupon. It is possible that a coupon may be provided to a grocery shopper that is not a CSP customer. Thus, distribution occurs indirectly by a third party Merchant allocating the coupons.

In the above scenarios, it is possible that further information may be added, obtained, or otherwise recorded in the coupon file during distribution of the coupons. In such cases, the system doing so (if not the Coupon System) may transmit the altered Coupon File back to the Coupon System, so that the Coupon System maintains a current and complete coupon file.

### Coupon Redemption Process

Coupon redemption refers to the processing associated with a viewer redeeming a coupon for viewing a program. Referring briefly to FIG. 3, the redemption process involves the CSP 300 receiving a redemption request, to which the CSP 300 initiates a query to the Coupon System 100 to validate the coupon code. If the Coupon System 100 validates the code, then the CSP provides the requested program.

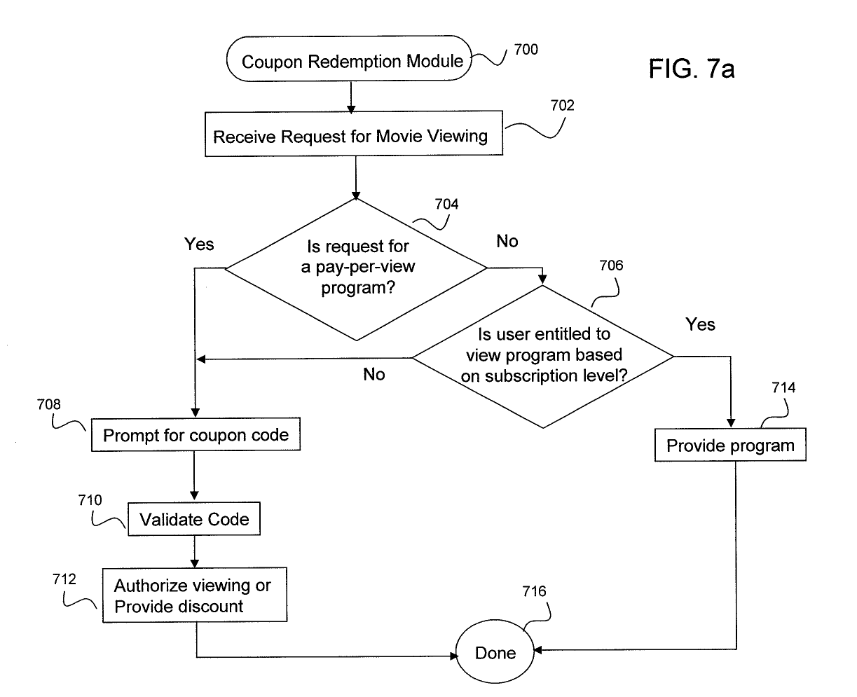

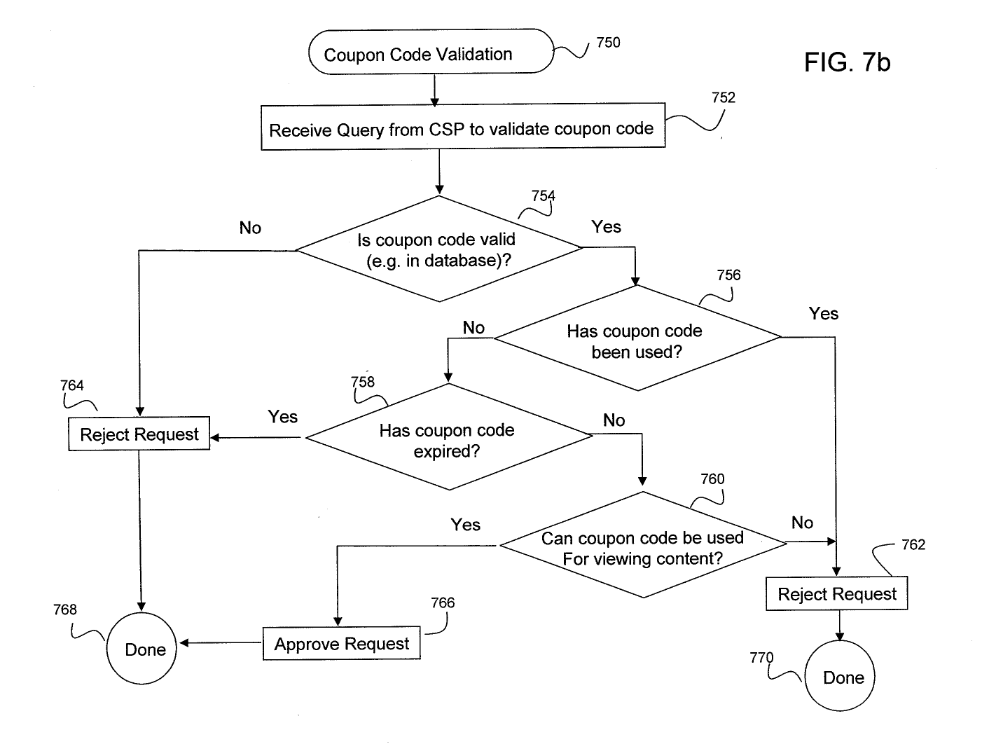

FIG. 7a illustrates one embodiment of the redemption processing associated with the CSP. In FIG. 7a, the process 700 begins with the CSP receiving a request for viewing a movie 702. This request typically is based on existing procedures for invoking a program request, such as using existing VOD or PPV procedures. The CSP tests if the request is for a PPV program at step 704. If the program is a PPV, then the CSP proceeds to step 708 for prompting the user for a coupon code. If the program is not a PPV program, then the CSP tests if this is for a program that the user is entitled to receive based on their subscription level. If it is, then step 714 is performed, which provides the program to the user as they are entitled to view it. However, if the user is not entitled to view the program based on their subscription level, then the CSP will proceed to step 708 where the viewer is prompted for a coupon code. The coupon code is typically not used to provide access to program (such as a premium level channel) which the viewer is already able to access. Various other tests can be defined, and not all embodiments are required to have the same set of tests.

The viewer will respond with the coupon code, which in one embodiment is a alphanumeric set of digits. In this embodiment, it is numeric code of a certain number of digits which are entered by the viewer using the remote controller. The CSP in step 710 validates the code. Typically, this is accomplished by initiating a query to the Coupon System 100. This query can be formatted to any protocol, and typically would include information such as:

a. CSP service provider identification,

b. Identification of the program being requested,

c. Rating of the program being requested, and

d. Coupon code entered by viewer.

Other information may be included, such as identification of the subscriber making the request, time of the request, or other meta-data associated with the requested program. This meta-data can conform to industry standards for video program meta data. It should be noted that the information included in the query may vary from embodiment to embodiment. For example, some embodiments may provide identification of the program being requested (e.g., a program identifier), and the Coupon System could then ascertain the rating of the program being requested based on the program identifier. The Coupon System could use the program identifier to identify a meta-data file associated, which comprises information about the content provider or distributor, rating, and other information. In other embodiments, the program identification and rating may not be included, as the Coupon System may not use this information to compare against qualifier information stored in the coupon system. Thus, at the minimum, the coupon code would have to be provided, but beyond that, other information included may vary.

In some embodiments, some of the validating steps may occur in the Coupon System, with other validating steps occurring in another system. For example, the Coupon System may receive a query from a CSP, and perform certain validation steps. Then, assuming these steps pass validation, the Coupon System may initiate a query to another system for additional validation. More specifically, the CSP may originate a query to the Coupon System indicating a coupon code, a program identifier, and CSP identifier. The Coupon System may receive the query and determine that code must be further validated by a promoter or content distributor, which has promoted that particular program. Thus, the Coupon System may initiate in return another query to another system (which could be viewed as a distributed Coupon System), and when receiving a response validating the information, then respond to the CSP original's request. This allows a promoter to coordinate validation and redemption of coupon codes, which avoids the reliance on a single validation source. Thus, the promoter's system (which may appear as a duplicate of the Coupon System) may also process and regulate redemption of coupon codes.

The CSP receives a response from the Coupon System, which will indicate that the request is either accepted or rejected (not shown in FIG. 7a). If the request is rejected, then the CSP will inform the user that the coupon is not valid. Assuming the request is granted, then in step 712, the CSP authorizes viewing of the program. Appropriate discounts are taken if the program is a PPV. Typically, the response from the Coupon System will indicate a discount level so that the CSP can indicate the appropriate discount for that subscriber. Typically, the CSP will also inform the viewer that the coupon code is valid, and any discount. The process then completes in step 716.

One embodiment of the processing occurring in the Coupon System receiving the validation request is shown in FIG. 7b. In FIG. 7b, the process 750 begins with the Coupon System receiving a query from the CSP for validating a coupon code 752. In step 754, the Coupon System 100 determines if the coupon code is stored in the coupon file in the database. The coupon code may be a guess, reflecting a mere attempt by a subscriber to obtain a discount, and hence the number may not even be in the system database. Assuming the number does correspond to a coupon record, the record is retrieved and the Coupon System then determines if the limit of use of the coupon has been reached in step 756. Assuming the limit has not been reached, then processing next tests in step 758 whether the coupon code has expired. Assuming the coupon code has not expired, then the Coupon System next test in step 760 whether there are any restrictions regarding use of the coupon code for the requested program. The code may be limited for redemption for a specific movie, or type of movie. Thus, a code promoting “Movie X” cannot be used for obtaining a discount from “Movie Y”. Other examples include restricting use of a coupon code for certain types of programs based on rating, such as “adult” or “R” rated programs. Other restrictions can be defined. Thus, any of the fields in the coupon record comprises qualification data that can be used to validate the redemption request.

Assuming that all appropriate tests have passed, the Coupon System approves the request in step 766. This involves sending a response to the CSP, which also typically indicates that discount level to be provided to the viewer. The Coupon System also will note that the coupon has been used (redeemed), and this can be indicated by setting a flag or incrementing a counter in the coupon code record. The Coupon System may also note in the coupon record the CSP initiating the request, date, time, or other information. Such information can be used to analyze the redemption requests to obtain market intelligence. If any of the tests at step 754, 756, or 760 fail, then the system proceeds to steps 764 or 762 as appropriate, which rejects the request and sends an appropriate response to the CSP.

The nature and order which the steps that are performed can vary, and the type of test performed can vary as well. The Coupon System may perform other tests, such as testing whether the CSP is approved to make requests. The Coupon System may also receive information regarding the subscriber's identity and determine whether the viewer is somehow entering too many coupon codes. Thus, additional fraud prevention or other limiting tests can be performed. Thus, FIGS. 7a and 7b illustrate only one type of embodiment of the processing that may be performed.

### Illustrative Example

One embodiment of the invention is provided below and is based on a co-marketing arrangement between a grocery store chain and a CSP. In this arrangement, the grocery store has a “frequent shopper” program that rewards frequent shoppers. Shoppers are usually identified at checkout by providing a membership card (which is barcoded and scanned). Thus, the grocery store tracks each shopper's purchase, and allocates a reward based on some criteria. In this embodiment, a coupon for a free pay-per view movie (excluding adult movies) is provided to shoppers whose bill exceeds $100.

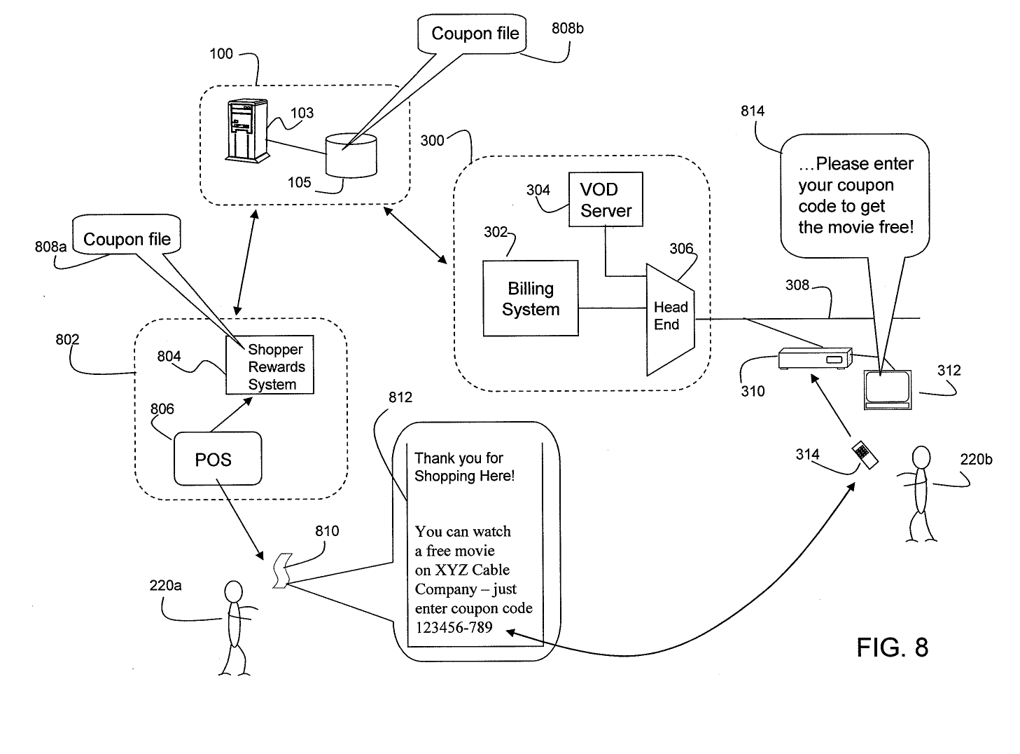

This can be illustrated with the aid of FIG. 8. In FIG. 8, the shopper 220a is at the grocery store and interacts with the grocery stores business systems 802 which comprise a point-of-sale (POS) system 806 that performs the traditional checkup functions. As part of checkout, the POS system 806 interacts with a shopper rewards system 804 that stores information about the shopper, their purchases, and can dynamically select and print out coupons on the sales receipt 810. The shopper rewards system 804 is presumed to have an “inventory” of coupons codes in a coupon file 808 stored in the shopper rewards system 804. The shopper rewards system 804 obtained the file 808 from the coupon system 100 at a prior time, before distribution of the code began. Typically, the promotional program must be coordinated between the Merchant, the Coupon System, and the CSP in advance to distribution of the coupons to the viewers.

When the shopper completes checkout, a receipt 810 is provided to the shopper. As is well known, the POS cooperating with the Shopper Rewards System 804 can dynamically print a coupon on the shopper's receipt. In this case, a coupon 812 is printed on the bottom of the receipt informing the shopper that a free pay-per-view movie can be redeemed from the XYZ Cable Company by entering the indicated coupon code.

The shopper 220b then returns to their house where they receive cable service from the XYZ cable service provider, and invokes a PPV program request using existing PPV procedures. This is accomplished using a remote controller 314, which the STB 310 processes. In some instances, an appropriate software program may be downloaded to the STB to modify processing of user requests for PPV programs in order to recognize and prompt the viewer for a coupon code. The prompt 814 can be displayed as a menu option on the television 312 that the viewer sees.

After entering the coupon code from the receipt, the information is sent to the STB and to the CSP 300 wherein a query is sent to the Coupon System 100 to determine if the code is valid. The validation involves the billing system initiating a query to the coupon system 100, which is received by the processor 103. The processor validates the coupon code by retrieving the appropriate coupon record as indexed by the coupon code from a coupon file database 105. The Coupon System 100 determines if the code is valid, if it has been used before, and whether the coupon code has expired. The Coupon System may also check to ensure that the program request is compatible with restrictions associated with the coupon code. For example, if the agreement between the grocery store and the CSP is to exclude using the coupon for adult movies, the Coupon System may check the requested program's rating against restrictions indicated in the database 105. Of course, the CSP will have to include this information in the query to the Coupon System.

Assuming these and any other tests are passed, the Coupon System responds to the CSP by affirming the coupon code is valid, and further indicating a discount level to the billing system 302. The billing system will provide an appropriate discount to the viewer's account and then instructs the VOD server to provide the requested program. The VOD server streams the program over the cable distribution network 308 to the STB 310, where it is displayed on the television 312.

This coupon codes in the coupon file 808a (which are also stored in a coupon file 808b in database 105) are allocated by the grocer to any shopper purchasing over $100 in groceries and are redeemable for any type of (non-adult) program on their local cable service provider. Of course, this presumes that the grocer, coupon system, and CSP have established the necessary agreements for cross promotional marketing. Although FIG. 8 discloses the Coupon System 100 serving a single grocer 802 and a single CSP 300, it is quite possible for multiple Merchants (and of different types) to be supported, as well as multiple CSPs. Thus, a Coupon system may have arrangements with multiple CSPs serving a geographical area, so that any coupons provided by the grocer are redeemable by the shoppers, regardless of which CSP serves the shopper. Further, it is possible for the Coupon System to serve multiple merchants. Thus, a CSP desiring to promote a program, could make arrangements with various merchants in their serving area allowing coupons to reach subscribers in different ways (e.g., via grocery stores, gas stations, convenience stores, ticket agencies, restaurants, etc.). In some embodiments, different coupon code ranges can be assigned to different merchants, allowing another mechanism for tracking how/where the coupon codes are redeemed.

In this embodiment, the coupon distributed to the shoppers can be considered as a “generic subscriber” and “generic program” coupons. However, other embodiments could associate the coupon code with redeeming only a specific movie. Thus, a promoter of a specific movie could arrange with the grocery store and the CSP to promote a specific movie. In this case, the query from the CSP indicates the requested program, and the Coupon System 100 checks that the code is being used for the appropriate program content. Thus, this would be a “generic subscriber” and “targeted program” type of coupon.

In the above embodiment, the Coupon System 100 could be owned by the CSP, the grocery store, or a third party. In particular, the systems could be geographically located in different locations, such that a LAN, WAN, or the Internet (not shown) can be used to provide communication between these systems. In other embodiments, the Coupon System 100 can be integrated with the Billing System 302, or otherwise co-located with the CSP. Further, in other embodiments, the functionality of the Coupon System 100 could be integrated with the shopper rewards system 804. Thus, although FIG. 8 illustrates one embodiment of the physical architecture, other variations are possible.

Those skilled in the art will recognize that many variations of the present invention are possible, than what is disclosed herein. Instead of a grocery shopper reward system, a frequent flyer reward system could be implemented. In other embodiments, electronic coupons could be distributed in conjunction with using a charge card, printed in portions of products (e.g., inside bottle caps or labels), or provided on printed cards as a promotional mailing.

That which is claimed:

1. A method for providing a video program to a subscriber of a cable service provider, comprising the steps of:
generating a coupon file comprising at least one coupon record in a coupon database, wherein said coupon record comprises a coupon code comprising alphanumeric information used by the subscriber of the cable service provider to view said video program;
transmitting at least a subset of said coupon codes to a computer system of a merchant that provides said coupon code to said subscriber;
receiving a request at a cable headend for viewing said video program from a set top box associated with said subscriber of said cable service provider, said request including a video program identifier indicating said video program;
determining by said cable service provider whether a subscription service level of the subscriber normally allows providing said video program to said subscriber;
receiving said coupon code at said cable service provider from said set top box in response to said subscriber entering said coupon code;
validating said coupon code by said cable service provider using said coupon record retrieved from said coupon database;
providing said video program to said subscriber after validating said coupon code if said subscription service level does not normally allow providing said video program to said subscriber; and
recording an indication in said coupon file indicating said coupon has been redeemed.

2. The method of claim 1 wherein validating said coupon code using said coupon record comprises comparing a rating associated with said program identifier with a program rating qualifier in said coupon record associated with said coupon code.

3. The method of claim 1 wherein validating said coupon code using said coupon record comprises comparing a title associated with said program identifier with a program title qualifier in said coupon record associated with said coupon code.

4. The method of claim 1 wherein the indication recorded in said coupon file further includes an identifier of the subscriber redeeming said coupon code.

5. The method of claim 1 wherein validating said coupon code using said coupon record comprises comparing a current date with an expiration date in said coupon record associated with said coupon code.

6. The method of claim 5 wherein validating said coupon code using said coupon record comprises comparing a content provider associated with said program identifier with a content provider qualifier in said coupon record associated with said coupon code.

7. The method of claim 5 wherein validating said coupon code using said coupon record comprises determining said coupon code has not been previously redeemed.

8. A method for providing a pay-per view video program to a subscriber of a cable service provider, comprising the steps of:
generating a coupon file comprising at least one coupon record in a coupon database, wherein said coupon record comprises a coupon code comprising alphanumeric information used by the subscriber of the cable service provider to view said pay-per view video program at a discount;
transmitting at least a subset of said coupon codes to computer system of a merchant that provides said coupon code to said subscriber;
receiving a request for viewing said pay-per-view video program from a set top box associated with said subscriber at a cable headend of said cable service provider, said request including a video program identifier indicating said pay-per view video program;
receiving said coupon code at said cable service provider from said set top box in response to said subscriber entering said coupon code;
validating said coupon code by said cable service provider using said coupon record retrieved from said coupon database;
generating a message from the cable service provider to the set top box for informing the subscriber of acceptance of said coupon code for redeeming said pay-per-view video program;
instructing a video on-demand server to provide said pay-per view video program to said subscriber in response to receiving said coupon code; and
recording an indication in said coupon file that said coupon code has been redeemed.

9. The method of claim 8 wherein validating said coupon code using said coupon record comprises ascertaining a discount level indicated in said coupon record and communicating said discount to a billing system of said cable service provider.

10. The method of claim 8 wherein validating said coupon code using said coupon record comprises determining a content provider indicated in said coupon record is associated with said program identifier.

11. The method of claim 8 wherein validating said coupon code using said coupon record comprises determining a rating indicator associated with said pay-per-view video program is compatible with a rating qualifier indicated in said coupon record.

12. The method of claim 8 wherein an expiration date of said coupon record is compared to a present date, and said present date is before said expiration date.

13. The method of claim 8 wherein validating said coupon code comprises initiating a query comprising said coupon code to a content provider's computing system, wherein a response is received there from indicating said coupon code is valid.

14. The method of claim 8 further comprising the step of determining whether a subscriber service level associated with said subscriber allows provision of said pay-per-view movie to said subscriber.

15. A system for processing a coupon code entered by a subscriber to a set top box on a cable system for requesting viewing a video program from a video on-demand server, said system comprising:
a coupon system configured to communicate with said cable system, said coupon system comprising:
a database comprising a plurality of coupon code records, wherein a coupon code record comprises a coupon code and meta data regarding a video program associated with redemption of said coupon code; and
a processor configured to:
provide said plurality of coupon records to a merchant's coupon generation system,
receive said one or more query messages comprising said coupon code and a program identifier of said video program transmitted from said cable system, wherein said cable system comprises a cable headend configured to receive a request for said video program from a set top box, said request comprising a video program identifier and said coupon code,
ascertain said coupon code is stored in said coupon record stored in said database,
validate said coupon code by using said coupon record and said program identifier to determine that said coupon code can be used to redeem said video program,
wherein if said coupon code can be used to redeem said video program then instructing a VOD server storing said video program to provide said video program to said subscriber,
and
record an indication of use of said coupon code in said coupon record in said database.

16. The system of claim 15 wherein said processor is configured to transmit a discount level for providing said video program to a billing system for generating a bill to said subscriber associated with providing cable service to said subscriber.

17. The system of claim 15 wherein said processor is configured to compare said program identifier with movie redemption identifier data stored in said coupon code record, and determine that said program identifier corresponds to said movie redemption identifier.

18. The system of claim 15 wherein said processor is configured to compare the meta-data comprising an expiration date associated with said coupon code with a current date, and instructing said VOD server to provide said video program to said subscriber if said expiration date has not yet occurred.

19. The system of claim of 16 wherein said processor is configured to determine that a subscription service level of said subscriber would normally preclude providing said video program to said subscriber.

20. The system of claim 18 wherein said meta data comprises a content provider identifier, and said processor is configured to validate said coupon code by comparing said content provider identifier with a content provider associated with said program identifier.
